(19) United States
(12) Patent Application Publication
(10) Pub. No.: US 2009/0273316 A1
(43) Pub. Date: Nov. 5, 2009

(54) Method and Device for Recharging a Mobile Device Such As a Headset

(75) Inventor: Barry J. Lee, Santa Cruz, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: Plantronics, Inc., Santa Cruz, CA (US)

(21) Appl. No.: 12/114,943

(22) Filed: May 5, 2008

(51) Int. Cl. H02J 7/00; H02J 3/32; G08B 5/00; G08B 21/00

(52) U.S. Cl. 320/138; 307/48; 340/815.4; 340/636.1

(57) ABSTRACT

A recharging system for recharging a rechargeable battery of a mobile device such as a headset is disclosed. The recharging system includes a rechargeable system battery, a first connector configured to connect the recharging system to the mobile device, a second connector configured to connect the recharging system to a source of electrical power, and a controller configured to direct electrical power as required.

### FIELD OF THE INVENTION

The present invention relates generally to the field of headsets, including those used with telephone communication and other mobile electronic devices.

### BACKGROUND OF THE INVENTION

A variety of mobile electronic devices are in widespread use today and many include rechargeable batteries. Examples of such devices include the iPOD and similar devices for playing music, the Blackberry and other personal information managers, and headsets for voice communication.

Headsets of various types are commonly used for telephone or radio communication. With reference to FIGS. 1 and 2 a conventional wireless headset 10 is shown, including a microphone 12, volume and mute buttons 14, on-off button 16 and indicator light 18. A soft gel ear tip 20 allows the user to insert the tip 20 into the ear so that the headset 10 is supported by the user's ear for hands-free, wireless operation. The headset 10 also includes a rechargeable battery, not shown, and a jack, not shown, is located near the microphone 12 to permit recharging.

A variety of systems have been developed to recharge a headset battery. One example, shown in FIG. 3, comprises a “recharging pocket” 22. The recharging pocket 22 is open at one end and closed at an opposite end. A jack, not shown, is located at the closed end and the jack is connected to a plug, not shown, located inside the recharging pocket 22 near the jack.

In FIG. 4, one method of recharging the headset 10 is shown. In this method the user inserts the headset 10 into the recharging pocket 22 so that the jack of the headset engages the plug of the recharging pocket 22. The user then engages an AC charger 30 by connecting a plug 32 of the AC charger to the jack of the recharging pocket 22 and plugging a transformer 34 of the AC charger 30 into a wall outlet 36.

In FIG. 5 another method of recharging the headset 10 is shown. In this method a AAA battery 40 is inserted into a battery-powered charger 42, and the battery-powered charger 42 is connected to the recharging pocket 22. Thus power from the battery 40 recharges the rechargeable battery in the headset 10.

In FIGS. 6, 7 and 8 another method of recharging the battery of headset 10 is shown. In this method a mini-USB to USB charging cable 50 includes a cable 52 with USB plug 54 mounted at one end and a mini-USB plug 56 mounted at the other end. A mini USB charger 60 includes a mini USB jack 62 at one end which can be engaged with the mini USB plug 56, and at the opposite end the mini USB charger 60 includes a plug 64 which can be engaged with the jack of the recharging pocket 22. In operation the user inserts the USB plug 54 into a USB jack 70 of a computer, attaches the mini USB charger 60 to the recharging pocket 22 and connects the USB plug 54 to the USB jack 62. Thus electrical power supplied by the USB jack 70 recharges the battery of the headset 10.

It can be seen that the recharging pocket discussed above and illustrated in FIG. 3 is useful in a variety of circumstances but has certain shortcomings. The recharging pocket is capable of operating when connected to a stationary source of power as in FIG. 4 and with a mobile source of power as illustrated in FIG. 5, but the recharging pocket must be connected to certain components for stationary use and with certain different components when used in a mobile fashion. Furthermore, when the recharging pocket is used with a USB port a third, separate component must be used with recharging pocket. The requirement for multiple, separate components can be inconvenient for a user, and an integrated system would provide convenience.

Accordingly, it can be seen that improved methods and systems for recharging batteries in headsets and other mobile electronic devices are desirable.

### BRIEF SUMMARY OF THE INVENTION

An embodiment of the recharging system includes a rechargeable system battery; a first connector configured to connect the recharging system to the mobile device such as a headset; a second connector configured to connect the recharging system to a source of electrical power such as the USB port of a computer, and a controller configured to direct electrical power as required.

The recharging system can operate in two modes—“Connected” and “On-the-go”. In the “Connected” mode, when the USB plug of the recharging system is connected to a USB port of a computer a controller causes a bypass switch to direct power to charge the rechargeable system battery if recharging is necessary. On the other hand, in the “On-the-go” mode, when the USB plug of the recharging system is not connected to a USB plug the controller causes the bypass switch to direct power from the rechargeable system battery to charge the rechargeable battery of the mobile device if recharging is necessary. Also, if during the “Connected” mode the mobile device is connected to the recharging system, power from the USB port can also be directed to recharge the battery of the mobile device if necessary. In each of these cases, the controller is configured to determine which, if any, of the rechargeable batteries requires recharging and to control the bypass switch to direct current appropriately.

Further features and advantages of the present invention, as well as the structure and operation of the above-summarized and other exemplary embodiments of the invention, are described in detail below with respect to accompanying drawings, in which like reference numbers are used to indicate identical or functionally similar elements.

### BRIEF DESCRIPTION OF THE DRAWINGS

FIG. 1 illustrates a conventional wireless headset;

FIG. 2 is another view of the conventional wireless headset of FIG. 1;

FIG. 3 is an illustration showing a conventional recharging pocket for a wireless headset;

FIG. 4 illustrates the operation of the recharging pocket shown in FIG. 3;

FIG. 5 illustrates another method of operating the recharging pocket shown in FIG. 3;

FIG. 6 illustrates a conventional component of a system for recharging a headset using the USB port of a computer;

FIG. 7 illustrates another conventional component of a system for recharging a headset using the USB port of a computer;

FIG. 8 illustrates a conventional system for recharging a headset using the USB port of a computer with the components shown in FIGS. 6 and 7;

FIG. 9 is an isometric illustration of an embodiment of the present recharging system;

FIG. 10 is a schematic illustration of the electronic components of the recharging system of FIG. 9;

FIG. 11 is an isometric illustration of another embodiment of the present recharging system; and

FIG. 12 is an isometric illustration of another embodiment of the present recharging system.

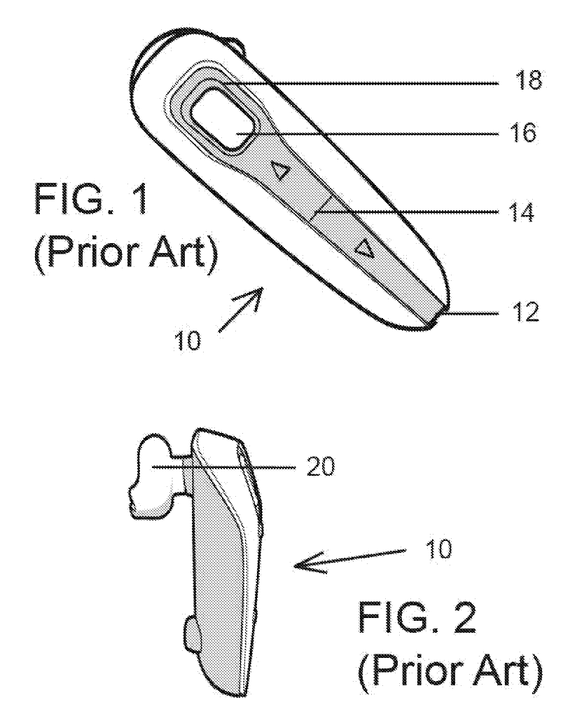

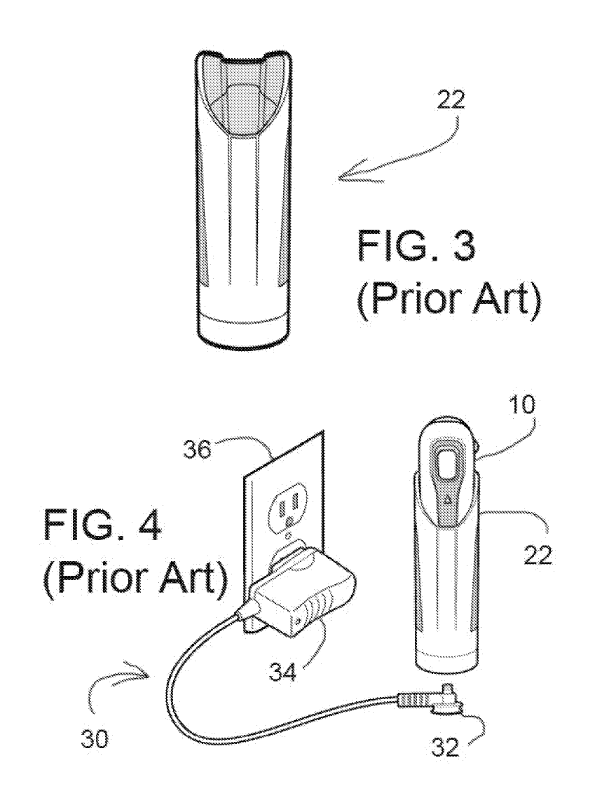

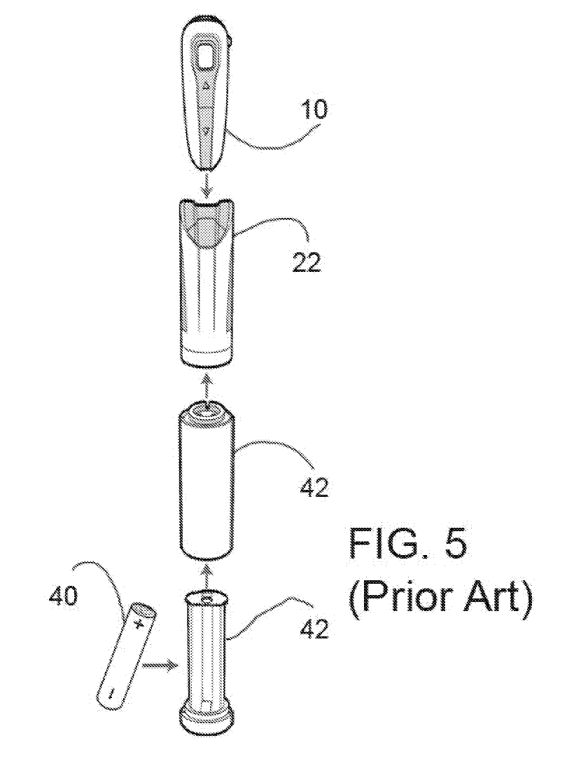

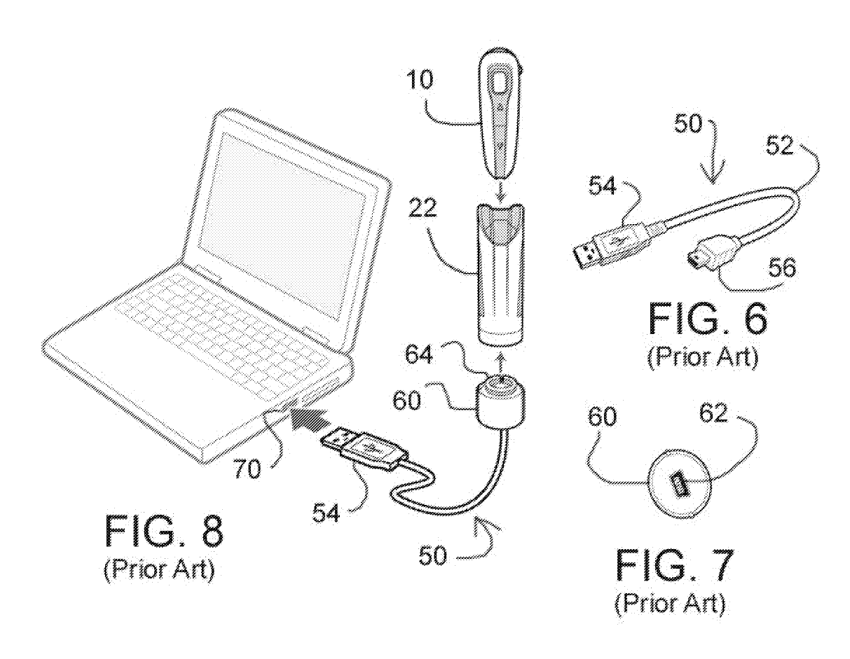

### DETAILED DESCRIPTION

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and

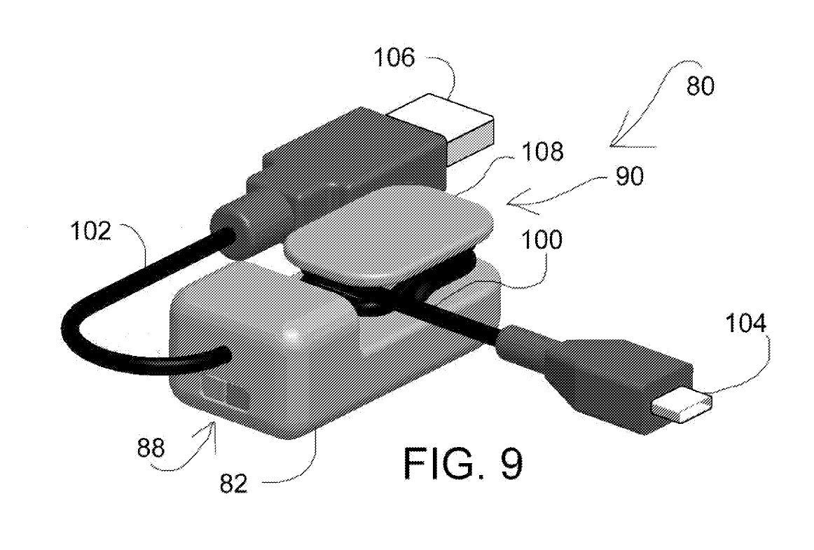

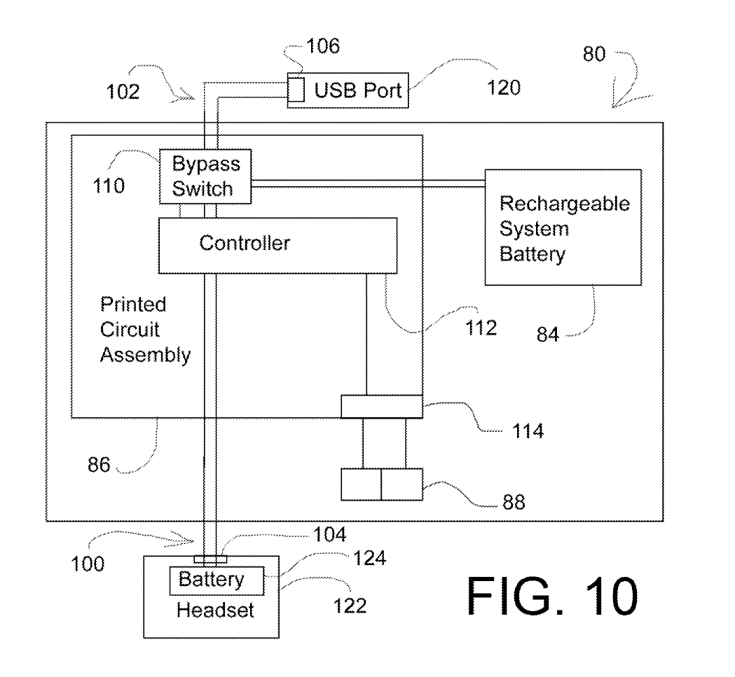

With reference to FIGS. 9 and 10 an embodiment of the present headset recharging system is shown. The headset recharging system 80 includes a base 82 which contains a rechargeable system battery 84 and a printed circuit assembly 86. The base also includes two status indicator lights 88 mounted in one end of the base, and a cable winding member 90 mounted on the top of the base 82. A first cable 100 is mounted to the top of the base 82 although the point of connection is not shown, and a second cable 102 is mounted to the end of the base 82 near the status indicator lights 88.

A mini-USB plug 104 is mounted at the end of the first cable 100, and a USB plug 106 is mounted at the end of the second cable 102. The cable winding member 90 is roughly T-shaped in cross section, having an upright section, not shown, with the base of the upright section mounted to the top of the base 82. A horizontal section 108 is located at the top of the upright section. The cable winding member 90 allows the user to adjust the length of the first cable 100 by winding the cable, as illustrated in FIG. 9, and unwinding the first cable 100.

The second cable 102 is connected to a bypass switch 110 mounted on the printed circuit assembly 86, and the bypass switch is electrically connected to the rechargeable system battery 84 and to a controller 112. The controller is also electrically connected to the first cable 100 and to an indicator light driver 114. The indicator light driver is electrically connected to status indicator lights 88. The controller 112 is configured to operate the bypass switch 110 to control the flow of electric current between the second cable 102, the rechargeable system battery 84 and the first cable 100.

In operation the USB plug 106 can be connected to a USB port 120 of a computer and the mini USB plug 104 can be connected to the mini USB socket of a rechargeable headset 122. The controller 112 then can engage bypass switch 110 to cause current to flow from the USB port 120 to recharge the rechargeable system battery 84 or the rechargeable headset battery 124 or both rechargeable batteries depending on the circumstances.

It can now be appreciated that the headset recharging system 80 can operate in two modes—“Connected” and “On-the-go”. In the “Connected” mode, when the USB plug 106 of the headset recharging system 80 is connected to a USB port of a computer the controller 112 causes the bypass switch 110 to direct power to charge the rechargeable system battery 84 if recharging is necessary. On the other hand, in the “On-the-go” mode, when the USB plug 106 of the headset recharging system 80 is not connected to a USB plug 106 the controller 112 causes the bypass switch 110 to direct power from the rechargeable system battery 84 to charge the rechargeable headset battery 124 if recharging is necessary. Also, if during the “Connected” mode the headset 122 is connected to the headset recharging system 80, power from the USB port 120 can also be directed to recharge the headset battery 124 if necessary. In each of these cases, the controller 112 is configured to determine which, if any, of the rechargeable batteries requires recharging and to control the bypass switch 110 to direct current appropriately.

The indicator light driver 114 causes the indicator lights 88 to light up according to various conditions of the system. For example, the indicator light driver 114 can be configured to cause the indicator lights 88 to indicate the status of the charge of the rechargeable system battery 84. Alternatively the indicator light driver 114 can be configured so that the indicator lights 88 indicate whether the rechargeable system battery 84 is being charged.

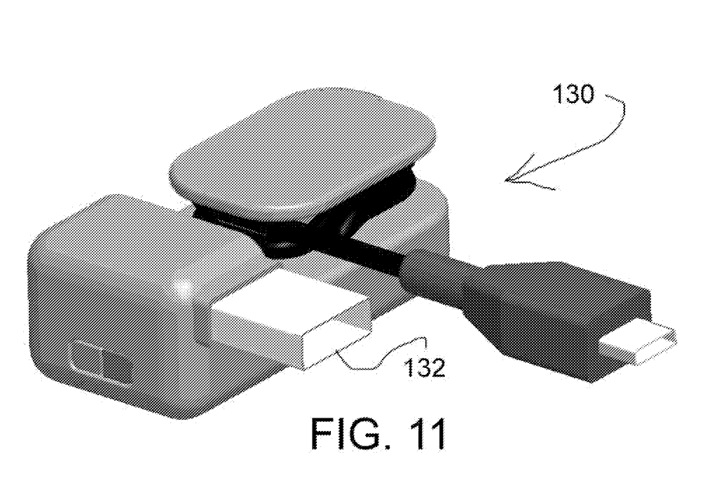

FIG. 11 shows another embodiment of the present invention. In this figure a headset recharging system 130 is shown, and the system 130 includes a connector 132 instead of the second cable 102 and USB plug 106. The connector 132 permits connection to compatible electrical cables and devices.

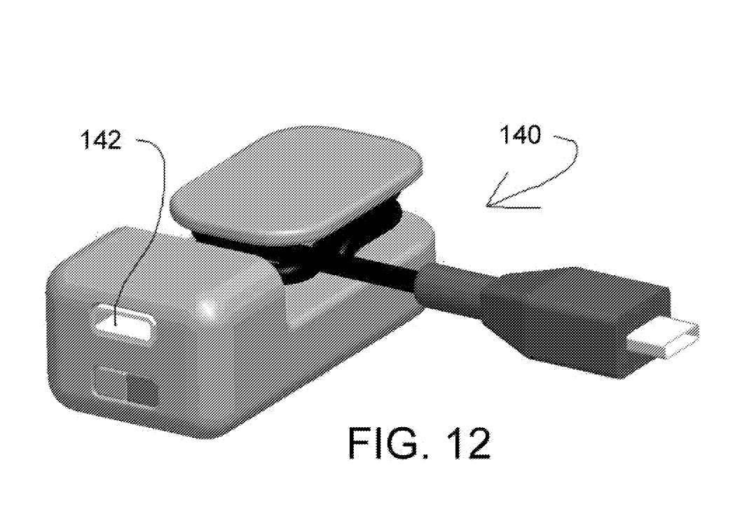

FIG. 12 shows another embodiment of the present invention. In this figure a headset recharging system 140 is shown, and the system 140 includes a socket 142 instead of the second cable 102 and USB plug 106. The socket 142 permits connection to compatible electrical cables and devices.

It should be recognized that although the system described above has been discussed in the context of a headset having a rechargeable battery, other mobile devices which include a rechargeable battery can also be used with the present recharger. For example, the present recharger can be used to recharge the batteries of a mobile MP3 device or a mobile, handheld personal information manager such as a Blackberry.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. Accordingly, the scope of the invention should not be restricted to the specific exemplary embodiments disclosed herein, and all modifications that are readily suggested to those of

What is claimed is:

1. A recharging system for recharging a rechargeable battery of a mobile device, the recharging system, comprising:
a rechargeable system battery;
a first connector configured to connect the recharging system to a mobile device;
a second connector configured to connect the recharging system to a source of electrical power; and,
a controller configured to:
a) direct power from the rechargeable system battery to the mobile device when the battery of the mobile device requires charging and the source of electrical power is not connected to said recharging system; and
b) direct power from the source of electrical power to the mobile device when the battery of the mobile device requires charging and the source of electrical power is connected to said recharging system.

2. The recharging system according to claim 1 wherein said mobile device is a headset.

3. The recharging system according to claim 1 wherein said controller is configured to direct power from the source of electrical power to the rechargeable system battery when the rechargeable system battery requires charging and the source of electrical power is connected to said recharging system.

4. The recharging system according to claim 1 wherein said second connector is configured to be connectable to a USB port of a computer.

5. The recharging system according to claim 1 wherein said first connector is configured to be connectable to a micro-USB port of a mobile device.

6. The recharging system according to claim 1, further comprising a status indicator.

7. The recharging system according to claim 6 wherein said status indicator comprises a light.

8. The recharging system according to claim 6 wherein said status indicator is configured to indicate when said controller is directing power from the rechargeable system battery to the mobile device.

9. The recharging system according to claim 6 wherein said status indicator is configured to indicate when said controller is directing power from the source of electrical power to the mobile device.

10. A recharging system according to claim 6 wherein said status indicator is configured to indicate when said controller is directing power from the source of electrical power to the rechargeable system battery.

11. The recharging system according to claim 6 wherein said first connector comprises a cable and a connection member.

12. The recharging system according to claim 11, further comprising a base and a cable length controller.

13. The recharging system according to claim 12 wherein said cable length controller comprises a cable winding member.

14. A method of operating a recharging system which includes a rechargeable system battery, the method comprising:
connecting the recharging system to a mobile device and connecting the recharging system to a source of electrical power;
directing power from the source of electrical power to the mobile device when the battery of the mobile device requires charging; and
directing power from the source of electrical power to the rechargeable system battery when the rechargeable system battery requires charging.

15. The method according to claim 14, further comprising the steps of:
disconnecting the recharging system from the source of electrical power; and
directing power from the rechargeable system battery to the mobile device when the battery of the mobile device requires charging.

16. The method according to claim 14 wherein said mobile device includes micro-USB port to receive power from the recharging system.

17. The method according to claim 14 wherein said source of electrical power comprises a USB port of a computer.

18. The method according to claim 14, further comprising indicating whether power is being directed from the source of electrical power to the mobile device.

19. The method according to claim 14, further comprising indicating whether power is being directed from the source of electrical power to the rechargeable system battery.

20. The method according to claim 14, further comprising indicating whether power is being directed from the rechargeable system battery to the mobile device.

21. The method according to claim 14 wherein the step of directing power from the rechargeable system battery to the mobile device when the battery of the mobile device requires charging occurs only when the source of electrical power is not connected to said recharging system.
